(19) United States
(12) Patent Application Publication
(10) Pub. No.: US 2014/0258214 A1
(43) Pub. Date: Sep. 11, 2014

(54) INFORMATION PROCESSING SYSTEM, INFORMATION REGISTRATION METHOD, AND CONFERENCE APPARATUS

(71) Applicant: Yuka TSUKAMOTO, Tokyo (JP)

(72) Inventor: Yuka TSUKAMOTO, Tokyo (JP)

(73) Assignee: RICOH COMPANY, LTD., Tokyo (JP)

(21) Appl. No.: 14/196,052

(22) Filed: Mar. 4, 2014

(30) Foreign Application Priority Data
Mar. 7, 2013 (JP) 2013-045785

(51) Int. Cl. G06F 17/30

(52) U.S. Cl. CPC G06F 17/30011
USPC 707/608

(57) ABSTRACT

An information processing system has a conference apparatus, a document management apparatus, and a plurality of terminal apparatuses interconnected via a network. The information processing system includes a conference information management unit that prompts the conference apparatus to manage conference information including information on an electronic conference, content shared by the terminal apparatuses at the electronic conference, and additional information added to the content at the terminal apparatuses; a document registration unit that registers document information corresponding to the conference information managed by the conference apparatus in the document management apparatus and prompts a transition from management by the conference apparatus to management by the document management apparatus; a document information management unit that manages the document information; and a display control unit that prompts the terminal apparatuses to visually display the additional information added to the content using the additional information included in the document information.

### BACKGROUND OF THE INVENTION

1. Field of the Invention

The disclosures herein generally relate to an information processing system, an information registration method, and a conference apparatus.

2. Description of the Related Art

In electronic conferences where conference materials are displayed on screens while relevant topics are discussed, techniques are known that enable easy storage and management of screen images of notes and markings made related to a discussion in association with display content relevant to the discussion (see e.g., Japanese Laid-Open Patent Publication No. 2007-280235).

Electronic conference systems may have functions for writing handwritten notes on a conference material or attaching a tag on the conference material, for example. However, in conventional electronic conference systems, such handwritten notes or tags are not effectively utilized after the conference is over.

### SUMMARY OF THE INVENTION

It is a general object of at least one aspect of the present invention to provide an information processing system, an information registration method, and a conference apparatus that are capable of enhancing the utility of additional information added to a conference material.

According to one embodiment of the present invention, an information processing system is provided that has a conference apparatus, a document management apparatus, and a plurality of terminal apparatuses interconnected via a network. The information processing system includes a conference information management unit that prompts the conference apparatus to manage conference information including information on an electronic conference, content shared by the plurality of terminal apparatuses at the electronic conference, and additional information added to the content at the plurality of terminal apparatuses; a document registration unit that registers document information corresponding to the conference information managed by the conference apparatus in the document management apparatus and prompts a transition from management by the conference apparatus to management by the document management apparatus, the document information being configured to be managed by the document management apparatus; a document information management unit that manages the document information; and a display control unit that prompts the terminal apparatuses to visually display the additional information added to the content using the additional information included in the document information.

According to another embodiment of the present invention, an information registration method is provided that is implemented by an information processing system having a conference apparatus, a document management apparatus, and a plurality of terminal apparatuses interconnected via a network. The information registration method includes a conference information managing step of having the conference apparatus manage conference information including information on an electronic conference, content shared by the plurality of terminal apparatuses at the electronic conference, and additional information added to the content at the plurality of terminal apparatuses; a registration step of registering document information corresponding to the conference information managed by the conference apparatus in the document management apparatus and prompting a transition from management by the conference apparatus to management by the document management apparatus, the document information being configured to be managed by the document management apparatus; a document information managing step of managing the document information; and a display controlling step of prompting the terminal apparatuses to visually display the additional information added to the content using the additional information included in the document information.

According to another embodiment of the present invention, a conference apparatus is provided that is included in an information processing system having the conference apparatus, a document management apparatus, and a plurality of terminal apparatuses interconnected via a network. The conference apparatus includes a conference information management unit that prompts the conference apparatus to manage conference information including information on an electronic conference, content shared by the plurality of terminal apparatuses at the electronic conference, and additional information added to the content at the plurality of terminal apparatuses; and a document registration unit that registers document information corresponding to the conference information managed by the conference apparatus in the document management apparatus and prompts a transition from management by the conference apparatus to management by the document management apparatus, the document information being configured to be managed by the document management apparatus. The conference apparatus is configured to prompt the document management apparatus to control the terminal apparatuses to visually display the additional information added to the content using the additional information included in the document information.

According to one aspect of the present invention, the utility of additional information added to a conference material may be enhanced.

### BRIEF DESCRIPTION OF THE DRAWINGS

FIG. 1 illustrates an exemplary configuration of an information processing system according to an embodiment of the present invention;

FIG. 2 illustrates an exemplary hardware configuration of a computer system used in an embodiment of the present invention;

FIG. 3 is a block diagram illustrating an exemplary functional configuration of a conference server according to an embodiment of the present invention;

FIG. 4 is a block diagram illustrating an exemplary functional configuration of a document management server according to an embodiment of the present invention;

FIG. 5 is a block diagram illustrating an exemplary functional configuration of a client terminal according to an embodiment of the present invention;

FIG. 6 illustrates an exemplary screen image of the client terminal that is operated by a participant of a conference;

FIG. 7 illustrates another exemplary screen image of the client terminal that is operated by a participant of a conference;

FIG. 8 illustrates an exemplary process of adding additional information to a conference material;

FIG. 9 is a flowchart illustrating an exemplary process of attaching a tag to a conference material;

FIG. 10 is a flowchart illustrating an exemplary process of setting up the document management server for storing a conference material;

FIG. 11 is a flowchart illustrating an exemplary process of registering information in the document management server;

FIG. 12 illustrates a relationship between conference information and document information;

FIG. 13 illustrates an exemplary screen for setting up access authority in the document management server;

FIG. 14 illustrates an exemplary search screen;

FIG. 15 illustrates another exemplary search screen;

FIG. 16 illustrates another exemplary search screen;

FIG. 17 illustrates an exemplary document list screen; and

FIG. 18 illustrates an exemplary viewer screen.

### DESCRIPTION OF THE PREFERRED EMBODIMENTS

In the following, embodiments of the present invention are described with reference to the accompanying drawings.

### First Embodiment

### System Configuration

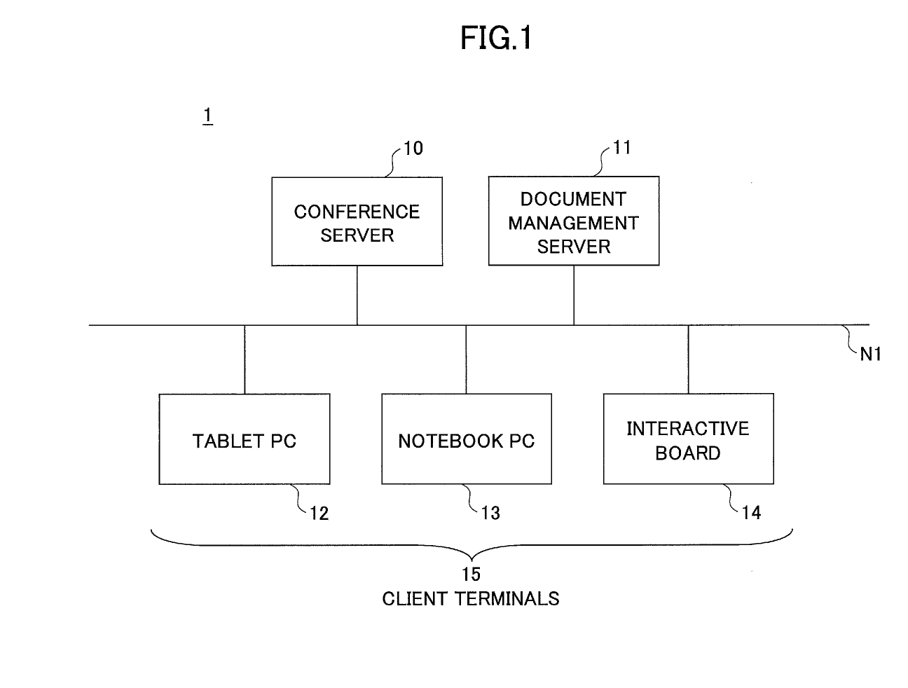

FIG. 1 illustrates an exemplary configuration of an information processing system according to an embodiment of the present invention. The information processing system 1 of FIG. 1 includes a conference server 10, a document management server 11, a tablet PC 12, a notebook PC 13, and an interactive board 14 that are interconnected by a network N1 such as a LAN (local area network). The tablet PC 12, the notebook PC 13, and the interactive board 14 are examples of a client terminal 15.

The conference server 10 may be implemented by software or a service run on a plurality of computers, for example. The conference server 10 may also be implemented by software or a service run on a single computer. In some embodiments, the conference server 10 may be a cloud service. The conference server 10 performs various processes related to a conference as described below.

The document management server 11 may be implemented by software or a service run on a plurality of computers, for example. The document management server 11 may also be implemented by software or a service run on a single computer. In some embodiments, the document management server 11 may be a cloud service. The document management server 11 performs various processes related to document management as described below.

The client terminal 15 is an information processing apparatus that is operated by a participant of a conference. The client terminal 15 may be a device such as a desktop PC (personal computer) or a smartphone, for example. Note that although three client terminals 15 are illustrated in FIG. 1, the number of client terminals 15 included in the information processing system 1 of the present embodiment is not limited to a particular number.

A conference material for a conference may be registered in the conference server 10 beforehand by a participant of the conference. For example, the client terminal 15 may accept conference information including the conference material input by the participant and register the input conference information in the conference server 10.

A participant of a conference may bring in his/her own client terminal 15 to a conference room and have the client terminal 15 display the conference material during the conference. For example, the client terminal 15 may accept a conference selection from the participant. In turn, the client terminal 15 receiving the conference selection may acquire the conference material for the selected conference from the conference server 10 and display the conference material.

Note that in the present embodiment, any participant of the conference may be a presenter of the conference. The client terminals 15 operated by participants other than the presenter may be arranged to be in synch with the screen of the client terminal 15 operated by the presenter. Processes related to synchronization of the client terminals 15 may be performed in conjunction with the conference server 10 as described below. Note that the interactive board 14 is an example of the client terminal 15 operated by the presenter or the client terminal 15 operated by some other participant of the conference.

For example, when a page of the conference material is turned at the client terminal 15 operated by the presenter, the page of the conference material displayed at the client terminals 15 operated by the other participants are also turned so that the client terminals 15 of the presenter and the other participants share the same screen. Further, when the presenter adds handwritten notes or attaches a tag to the conference material, or draws lines, marks, or characters on the conference material with a touch pen or a mouse, for example, such additional information may also be reflected on the screens of the client terminals 15 operated by the other participants.

In this way, additional information such as handwritten notes or a tag attached to the conference material, or marks, lines, or characters drawn on the conference material by the presenter with a touch pen or a mouse (simply referred to as “additional information” hereinafter) may be shared by all participants of the conference. Thus, the participants may deepen their understanding of the conference material being presented and have more meaningful discussions related to the conference material, for example.

After the conference is over, the conference server 10 may register and store the conference material in the document management server 11. To view the conference material and additional information after the conference is over, the participant of the conference may access the document management server 11 from the client terminal 15 and have the client terminal 15 display the conference material and additional information.

The document management server 11 may prompt the client terminal 15 to display the conference material with the additional information such as handwritten notes or a tag attached to the conference material so that the participant may visually perceive the conference material with the additional information added thereto.

<Hardware Configuration>

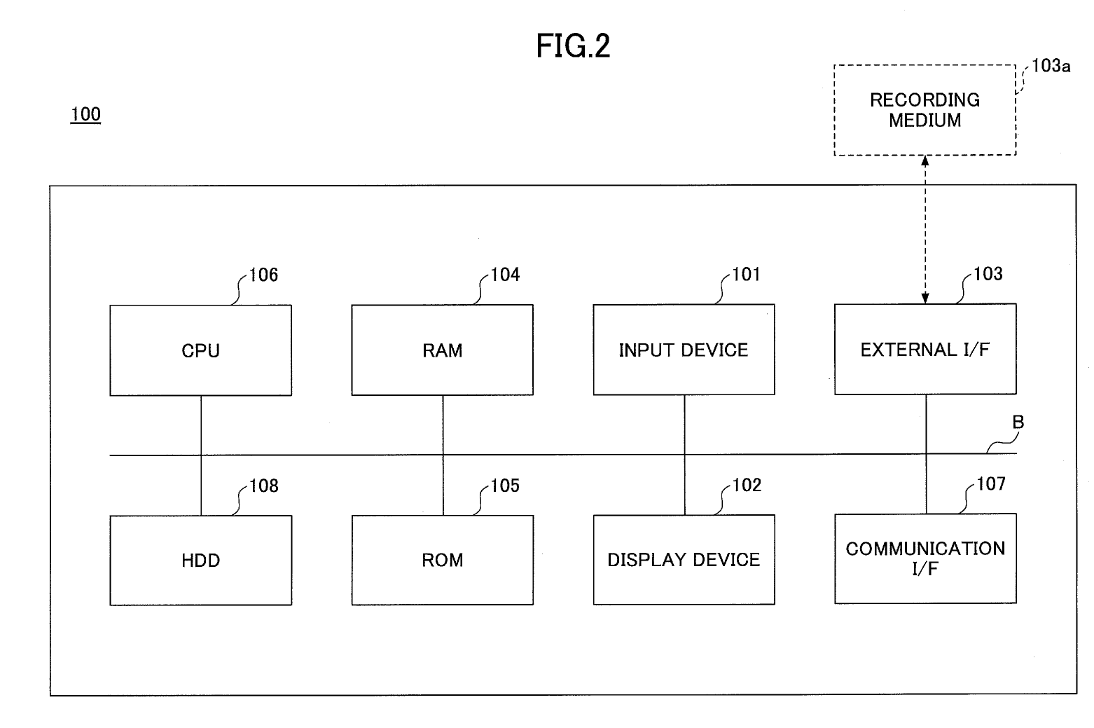

The conference server 10, the document management server 11, and the client terminal 15 may be implemented by a computer system 100 having a hardware configuration as illustrated in FIG. 2, for example.

FIG. 2 illustrates an exemplary hardware configuration of the computer system 100 according the present embodiment. The computer system 100 illustrated in FIG. 2 includes an input device 101, a display device 102, an external I/F 103, a RAM (Random Access Memory) 104, a ROM (Read-Only Memory) 105, a CPU (Central Processing Unit) 106, a communication I/F 107, and a HDD (Hard Disk Drive) 108, which are interconnected by a bus B.

The input device 101 may include a keyboard, a mouse, and a touch panel for inputting operation signals, for example. The display device 102 may include a display for displaying processing results obtained by the computer system 100, for example.

The communication I/F 107 is an interface for connecting the computer system 100 to the network N1. In this way, the computer system 100 may exchange data with other computer systems 100 via the communication I/F 107, for example.

The HDD 108 is a nonvolatile storage device storing programs and data. Examples of programs and data stored in the HDD 108 include an OS (Operating System) corresponding to basic software for controlling the entire computer system 100 and application software for providing various functions in the OS. The HDD 108 manages the stored programs and data by a predetermined file system and/or a DB (database).

The external I/F 103 is an interface between the computer system 100 and an external device. An example of the external device is a recording medium 103a. The computer system 100 may read data from and/or write data on the recording medium 103a via the external I/F 1503. Examples of the recording medium 103a include a flexible disk, a CD (Compact Disk), a DVD (Digital Versatile Disk), an SD memory card, and a USB memory (Universal Serial Bus memory).

The ROM 105 is a nonvolatile semiconductor memory (storage device) that can retain programs and data even after the power is turned off. The ROM 105 may store programs and data such as BIOS (Basic Input/Output System) that is executed when the computer system 100 is activated, OS settings, and network settings, for example. The RAM 104 is a volatile semiconductor memory (storage device) for temporarily storing programs and data.

The CPU 106 is a processor that controls and executes overall operations and functions of the computer system 100 by loading programs and data from storage devices such as the ROM 105 and the HDD 108 into the RAM 104 and executing relevant processes, for example.

The conference server 10, the document management server 11, and the client terminal 15 may execute various processes as described below by running relevant programs on the computer system 100 having the hardware configuration as described above, for example.

<Software Configuration>

<<Conference Server 10>>

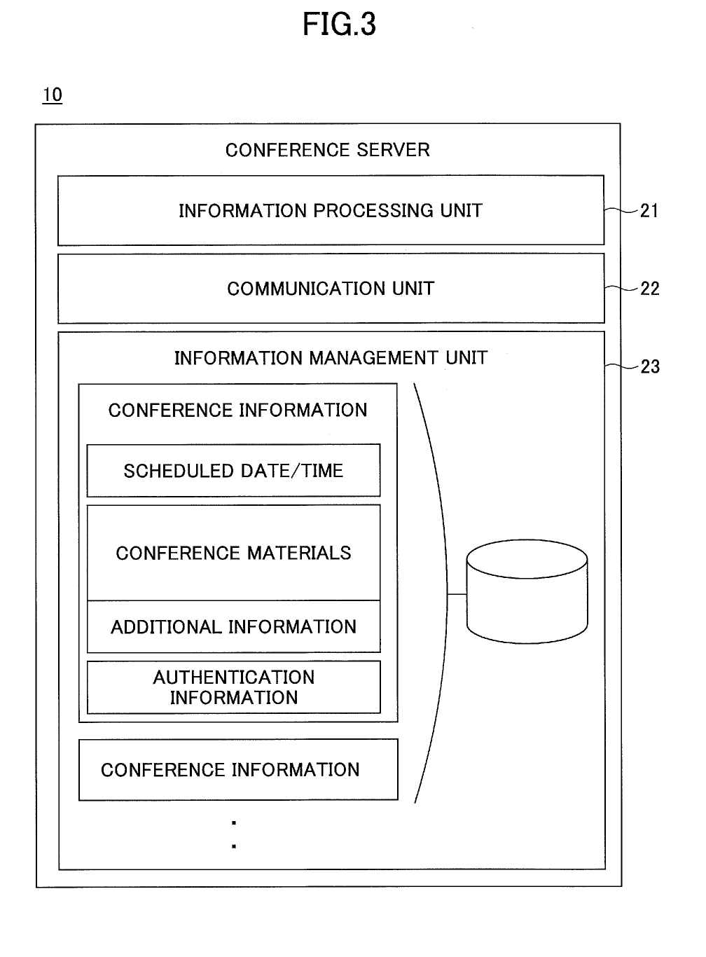

FIG. 3 is a block diagram illustrating an exemplary functional configuration of the conference server 10. In FIG. 3, the conference server 10 includes an information processing unit 21, a communication unit 22, and an information management unit 23 that may be implemented by executing relevant programs, for example. The information processing unit 21 performs information processing related to a conference. The communication unit 22 establishes communication between the conference server 10 and the document management server 11 or the client terminal 15, for example.

The conference server 10 includes at least one set of conference information for a conference that is registered beforehand by a participant of the conference, for example. The conference information is managed by the information management unit 23. The conference information may include information items such as scheduled date/time, conference material, additional information, and authentication information for participating in the conference, for example. The conference information is managed with respect to each conference. That is, the conference server 10 manages conference materials and additional information in association with each conference.

<<Document Management Server 11>>

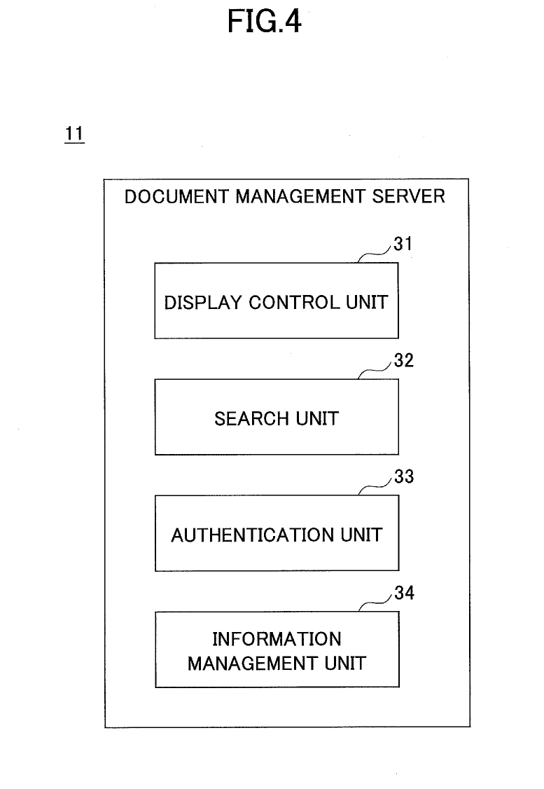

FIG. 4 is a block diagram illustrating an exemplary functional configuration of the document management server 11. In FIG. 4, the document management server 11 includes a display control unit 31, a search unit 32, an authentication unit 33, and an information management unit 34 that may be implemented by executing relevant programs, for example.

The display control unit 31 controls display operations of the client terminal 15. The search unit 32 provides a search function to the client terminal 15 as described in detail below. The authentication unit 33 performs authentication according to access authority settings of a document. The information management unit 34 manages document information. After a conference is over, the conference server 10 registers a document created based on the conference material and additional information in the document management server 11. Note that the process of registering the document from the conference server 10 to the document management server 11 is described in detail below.

<<Client Terminal 15>>

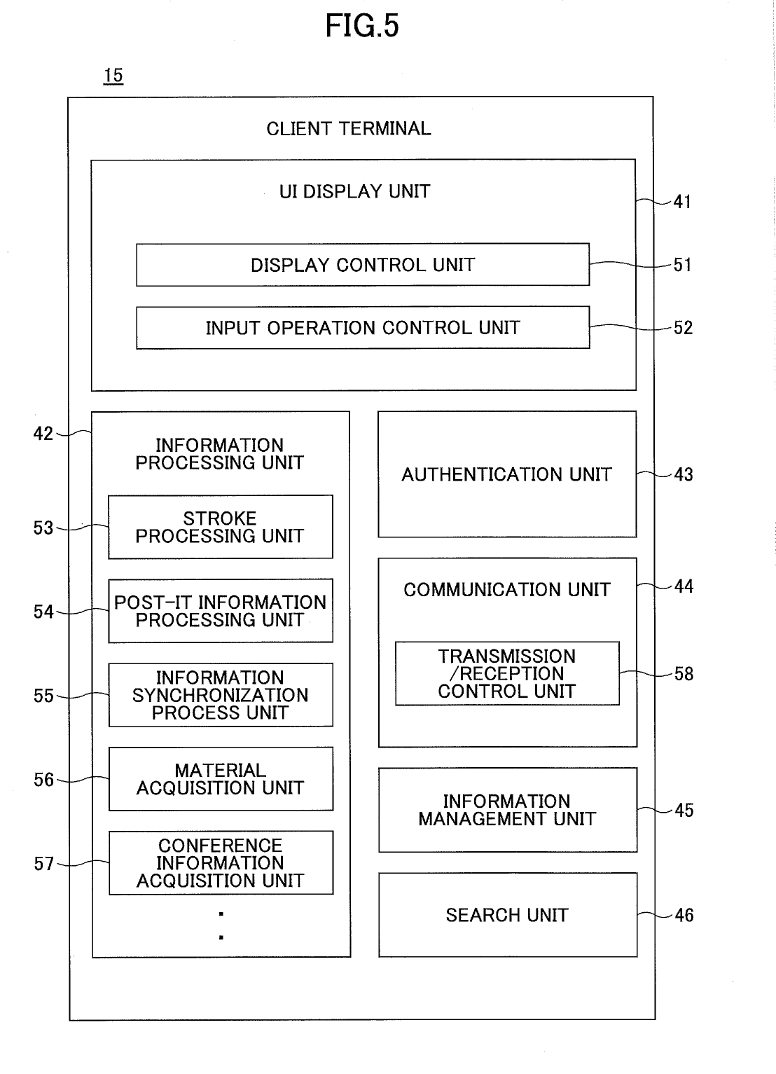

FIG. 5 is a block diagram illustrating an exemplary functional configuration of the client terminal 15. In FIG. 5, the client terminal 15 includes a UI display unit 41, an information processing unit 42, an authentication unit 43, a communication unit 44, an information management unit 45, and a search unit 46 that may be implemented by executing relevant programs, for example. The UI display unit 41 includes a display control unit 51 and an input operation control unit 52.

The information processing unit 42 includes a stroke processing unit 53, a tag information processing unit 54, an information synchronization process unit 55, a material acquisition unit 56, and a conference information acquisition unit 57. The communication unit 44 includes a transmission/reception control unit 58.

The UI display unit 41 controls operations relating to a UI (user interface). The display control unit 51 of the UI display unit 41 controls UI display operations. The input operation control unit 52 accepts an input operation from a conference participant, for example, and conveys the input operation to a predetermined destination.

The information processing unit 42 performs information processing in response to an input operation from a participant of a conference, for example. The stroke processing unit 53 of the information processing unit 42 performs processes related to strokes. For example, the stroke processing unit 53 may process a mark, a line, or a character drawn by a presenter on a conference material using a touch pen or a mouse, for example, as stroke information. The tag information processing unit 54 of the information processing unit 42 performs processes related to tags. For example, the tag information processing unit 54 may process a tag attached to a conference material as tag information.

The information synchronization process unit 55 performs processes for enabling the client terminal 15 operated by the presenter and the client terminals 15 operated by other participants to share the same screen. The material acquisition unit 56 acquires conference material and additional information from the conference server 10. The conference information acquisition unit 57 acquires conference information from the conference server 10.

The authentication unit 43 performs processes related to authentication. For example, the authentication unit 43 may perform an authentication process for enabling conference participation. The communication unit 44 establishes communication between the client terminal 15 and the conference server 10 or the document management server 11, for example. The transmission/reception control unit 58 of the communication unit 44 controls data transmission/reception between the client terminal 15 and the conference server 10 or the document management server 11, for example. The information management unit 45 manages information. The search unit 46 provides a search function.

<Detailed Processes>

In the following, detailed processes of the information processing system 1 of the present invention are described.

<<Process Overview>>

The client terminal 15 operated by a participant of a conference establishes connection with the conference server 10. The conference information acquisition unit 57 of the client terminal 15 acquires conference information other than conference materials and additional information from the conference server 10.

Based on the acquired conference information, the UI display unit 41 of the client terminal 15 displays conferences that are registered with the conference server 10. The participant of the conference operates the client terminal 15 to select the conference that he/she is attending from the conferences displayed at the client terminal 15. When a conference is selected, the material acquisition unit 56 of the client terminal 15 acquires the conference material and the additional information corresponding to the selected conference from the conference server 10.

Based on the acquired conference material and additional information, the UI display unit 41 displays the conference material with the additional information such as handwritten notes and tags attached thereto so that the participant may visually perceive the conference material with the additional information added thereto.

Note that in a case where authentication information is included in the acquired conference information, the authentication unit 43 requires the participant of the conference operating the client terminal 15 to input authentication information. The authentication unit 43 performs authentication by comparing the authentication information input by the participant with authentication information included in the conference information. Upon successful authentication, the material acquisition unit 56 of the client terminal 15 acquires the conference material and additional information for the selected conference from the conference server 10.

When a page of the conference material being displayed is turned by a presenter, the information synchronization process unit 55 of the client terminal 15 operated by the presenter sends page number information indicating the next page to be displayed to the conference server 10. When additional information is added to the conference material by the presenter, the information synchronization process unit 55 of the client terminal 55 operated by the presenter sends the additional information to the conference server 10.

Upon receiving the page number information indicating the next page of the conference material to be displayed and/or the additional information added to the conference material from the information synchronization process unit 55 of the client terminal 15 operated by the presenter, the information processing unit 21 of the conference server 10 sends the received information to the client terminals 15 operated by the other participants of the conference. Upon receiving the page number information indicating the next page of the conference material to be displayed and/or the additional information added to the conference material from the conference server 10, the display control units 51 of the client terminals 15 operated by the other participants updates their display screens according to the received information.

When a participant other than the presenter wishes to turn a page or add additional information to the conference material, the participant must first switch his/her client terminal 15 from share mode to private mode as described below. In private mode, even when a page is turned or additional information is added to the conference material, page number information or additional information is not conveyed to the conference server 10 and processes for sharing the same screen with the client terminals 15 operated by the other participants of the conference are not performed.

In private mode, only the display of the client terminal 15 that is operated to turn a page of the conference material or add additional information to the conference material is updated. That is, in private mode, operations for turning a page of the conference material or adding additional information to the conference material are performed asynchronously with respect to the client terminals 15 of the other participants.

After the conference is over, the conference material is temporarily stored in the conference server 10 together with the additional information added to the conference material. If additional information is asynchronously added to the conference material in private mode, such additional information is stored in association with a user ID in the conference server 10. Additional information stored in the conference server 10 may be converted into different data formats according to the type of information.

For example, the information processing unit 21 of the conference server 10 may merge (consolidate) stroke information with the conference material. The conference material merged with the stroke information may be stored in the document management server 11 as a document.

On the other hand, the information processing unit 21 of the conference server 10 does not merge tag information with the conference material. The information processing unit 21 sets up information items such as the color and content of the tag and the page number of the page to which the tag is attached as document properties (property information) of the conference material to be stored in the document management server 11.

To view the conference material and additional information from the client terminal 15, the participant of the conference may access the document management server 11 from his/her client terminal 15. In turn, the document management server 11 may prompt the client terminal 15 to display the conference material and the additional information in a manner such that the participant may visually perceive the conference material with the additional information such as handwritten notes or a tag attached to the conference material.

Note that the search unit 32 of the document management server 11 may receive a search request from the client terminal 15 and conduct a document search using a document property of document information. Document properties of document information include tag information, for example. Thus, the document management server 11 may conduct a search for conference material using the tag color and the tag content, for example.

<<Screen Image of Client Terminal During Conference>>

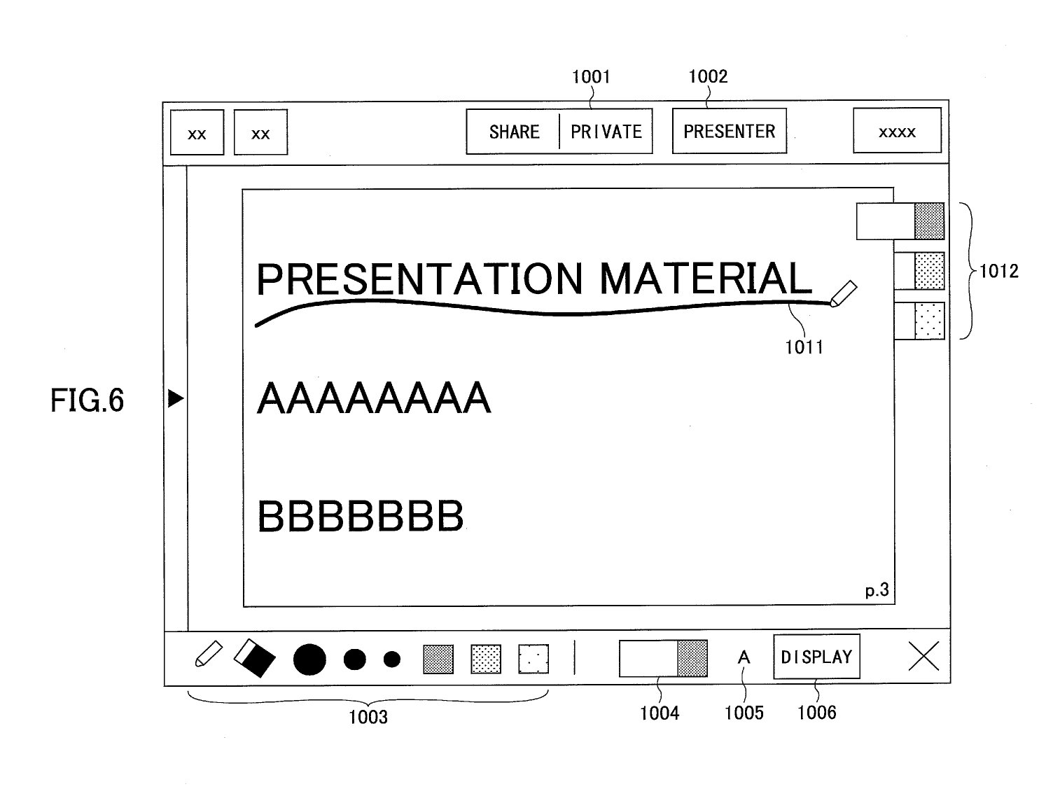

A participant of a conference may operate the client terminal 15 to display conference material as illustrated in FIG. 6, for example. FIG. 6 illustrates an exemplary screen of the client terminal 15 that is operated by the participant. The screen as illustrated in FIG. 6 displays the conference material and includes a function for adding additional information to the conference material and a function for switching between the presenter and other participants.

A share/private mode switch button 1001 accepts a request for switching between share mode and private mode from the participant. A presenter switch button 1002 accepts a request for switching between a presenter and a non-presenter from the participant.

The screen of FIG. 6 illustrates a stroke (handwritten information) 1011 and tags 1012 as examples of additional information added to the conference material. The stroke 1011 may be used to mark and emphasize an important part of the conference material, for example. The stroke 1011 may also be used to add a handwritten character string to the conference material, for example.

The tag 1012 may be attached to an important page or a page that needs to be reviewed later, for example, so that the page may be easily located and displayed. Also, a character string (comment) may be written in the tag as content and the content may be used in reviewing the page having the tag 1012 attached thereto, for example.

To add the stroke 1011 to the conference material, while a page of the conference material is displayed, the participant of the conference may select options related to handwriting such as a pen stroke width and a color from edit buttons 1003 and write the stroke 1011 by touching the screen or operating a mouse, for example. To add the tag 1012 to the conference material, while a page of the conference material is displayed, the participant may press a tag add button 1004, select the color of the tag to be added, and attach the tag 1012 to the displayed page, for example. In FIG. 6, the client terminal 15 operated by the participant displays the page of the conference material having the tag 1012 attached thereto.

By pressing a tag comment button 1005, the participant of the conference may prompt the client terminal 15 to display an edit screen for editing a comment for the tag 1012. Then, the participant of the conference may press a tag comment display button 1006 to display the comment for the tag 1012.

FIG. 6 illustrates a case where tags 1012 are attached to pages other than the page currently being displayed. In such a case, the participant of the conference may select the tag 1012 attached to a page other than the page currently being displayed (e.g., tap the tag 1012 if the screen includes a touch panel). In turn, the client terminal 15 may switch to displaying the page having the selected tag 1012 attached thereto.

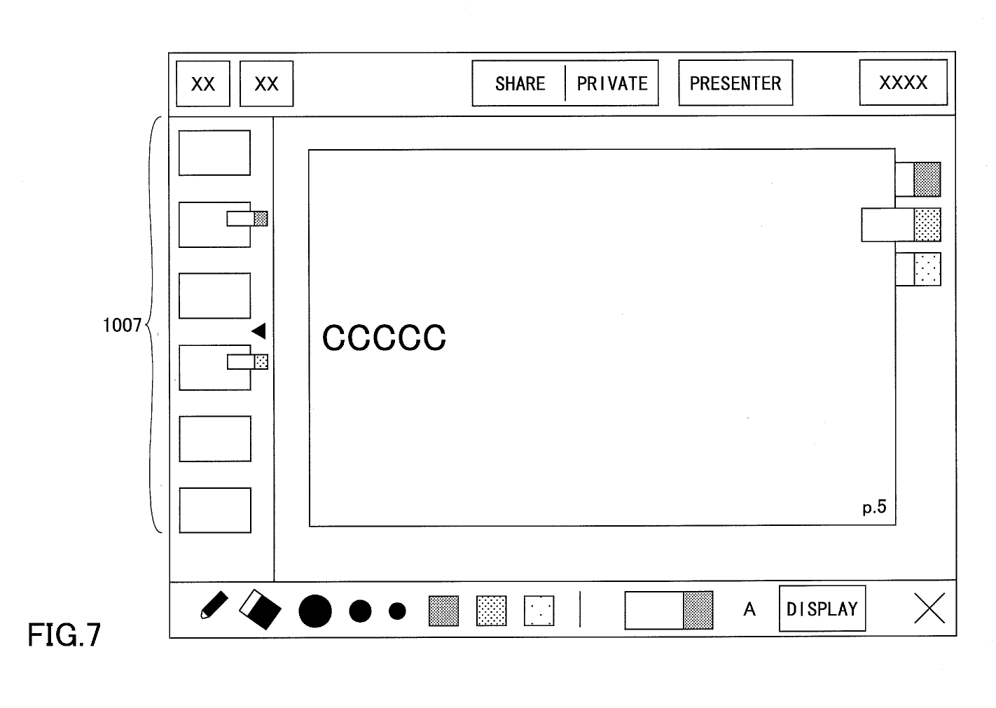

FIG. 7 illustrates another exemplary screen of the client terminal 15 operated by the participant of the conference. FIG. 7 illustrates an exemplary case where the second top tag 1012 in FIG. 6 is selected, and the client terminal 15 switches to displaying the page having the selected tag 1012 attached thereto, after which a thumbnail list is selected and displayed.

In the screen of FIG. 7, a thumbnail list 1007 is displayed at the left side. The thumbnail list 1007 displays thumbnail images of pages of the conference material. Note that the thumbnail images of pages having tags attached thereto are displayed as pages with tags.

<<Adding Additional Information to Conference Material>>

When the presenter of the conference adds additional information to the conference material, the client terminal 15 operated by the presenter sends the additional information to the conference server 10. In share mode, the conference server 10 sends the additional information added by the presenter to the client terminals 15 operated by the other participants of the conference. For example, if the additional information corresponds to stroke information, the conference server 10 may send information items such as pen color, pen stroke width, page, and stroke coordinate information to the client terminals 15 operated by the other participants of the conference. If the additional information corresponds to tag information, the conference server 10 may send information items such as tag color, page, and tag comment to the client terminals 15 operated by the other participants of the conference. In private mode, the conference server 10 does not send the additional information added by the presenter to the client terminals 15 operated by the other participants of the conference.

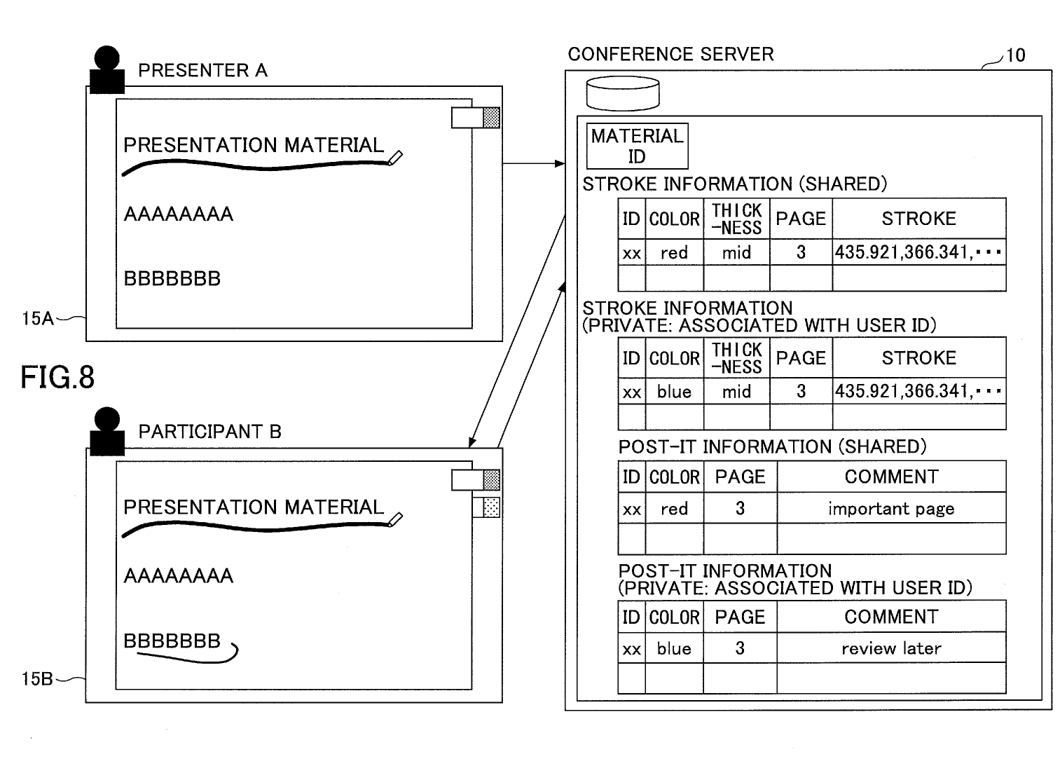

FIG. 8 illustrates an exemplary process of storing additional information including stroke information and tag information in the conference server 10. In FIG. 8, the stroke information and the tag information are stored in different tables depending on whether the stroke information and the tag information were added in share mode or in private mode. The stroke information and the tag information added in private mode are stored in association with a corresponding user ID identifying a specific participant of the conference.

After the conference is over, the conference server 10 registers the conference material and the additional information in the document management server 11 as described below. The conference server 10 may merge the stroke information with the conference material, convert the merged information into a prescribed data format such as PDF, and register the converted document in the document management server 11, for example. Also, the conference server 10 may register tag information as document properties of the conference material in the document management server 11.

<<Process of Attaching Tag to Conference Material>>

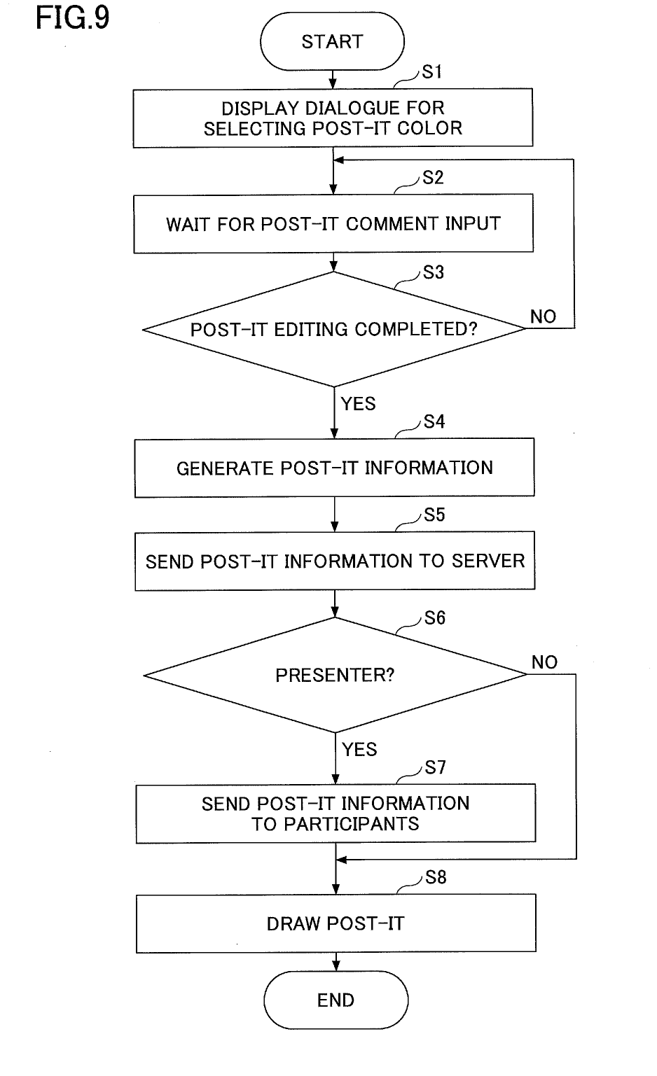

FIG. 9 is a flowchart illustrating process steps for attaching a tag to the conference material. A participant including the presenter of the conference may operate the client terminal 15 to display a page of the conference material to which a tag is to be attached. The participant of the conference may select the process of adding a tag to the conference material by pressing the tag add button 1004 as illustrated in FIG. 6, for example.

In step S1, the client terminal 15 operated by the participant of the conference displays a dialog for prompting selection of a tag color. In turn, the participant of the conference may operate the client terminal 15 to select a tag color from the dialog. After a tag color is selected by the participant of the conference, the client terminal 15 proceeds to step S2 where it awaits a tag comment input.

In step S3, the client terminal 15 operated by the participant of the conference repeats the process of step S2 until it determines that the participant has selected tag comment editing completion. After tag comment editing completion is selected by the participant, the client terminal 15 operated by the participant proceeds to step S4 where it generates tag information.

Note that the client terminal 15 operated by the participant may proceed to step S4 even if the tag comment field is empty (i.e., no comment is input) as long as the participant selects tag comment editing completion in step S3. In step S5, the client terminal 15 operated by the participant sends the generated tag information to the conference server 10.

In step S6, the conference server 10 determines whether the presenter attached the tag in share mode. If so, the conference server 10 proceeds to step S7 where it sends the tag information to the client terminals 15 operated by the other participants of the conference and stores the tag information. In step S8, the client terminals 15 operated by the presenter and the other participants of the conference may draw the tag on their screen as illustrated in FIG. 6, for example.

On the other hand, in the case where it is determined in step S6 that the tag was not attached by the presenter in share mode, the conference server 10 stores the tag information in association with a user ID of the participant, but does not send the tag information to the client terminals 15 of the other participants. If the tag is not attached by the presenter in share mode, the client terminal 15 that has sent the tag information to the conference server 10 in step S5 may draw the tag on its screen as illustrated in FIG. 6, for example.

Note that although a process of attaching a tag to the conference material is described in FIG. 9, similar process steps may be performed to add a stroke to the conference material. In a process of adding a stroke to the conference material, for example, process steps for writing a stroke may be performed in place of steps S1-S3 of FIG. 9, stroke information may be generated and sent in steps S4-S7, and the stroke may be drawn in step S8.

<<Process of Setting Up Storage of Conference Material>>

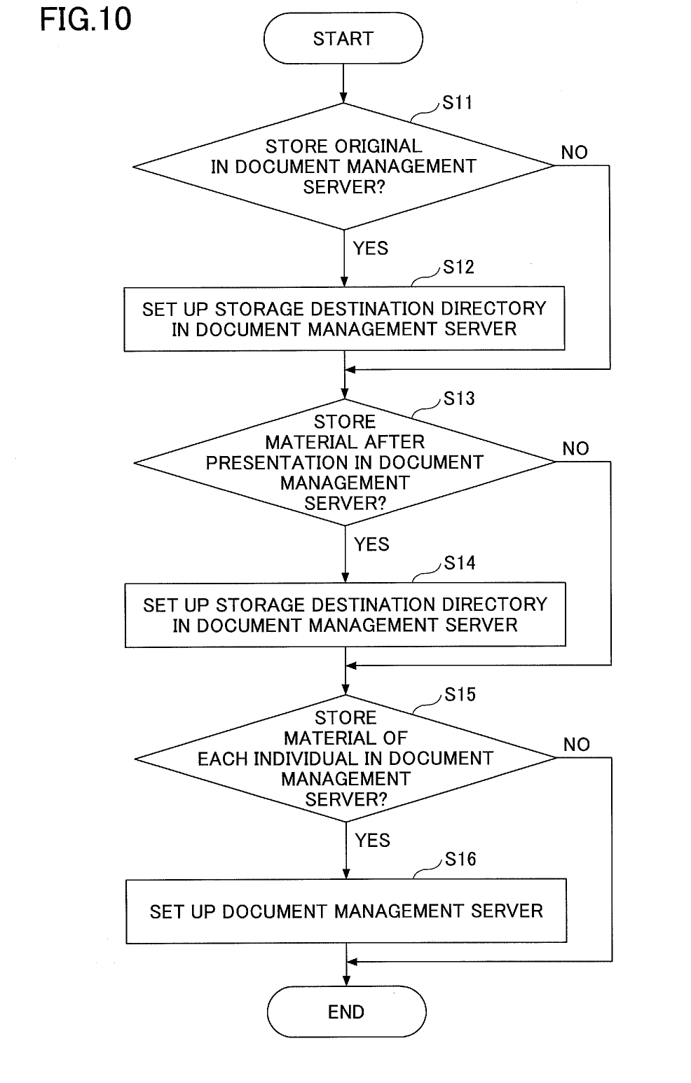

FIG. 10 is a flowchart illustrating exemplary process steps for setting up storage of the conference material. For example, organizers of the conference may set up how the conference material is to be stored after the conference is over according to the process steps illustrated in FIG. 10. Note that although it is assumed in the following descriptions that the process of setting up storage of the conference material is performed by the organizer of the conference upon registering the conference material beforehand, the process may also be performed by the presenter after the conference is over, for example.

In step S11, the organizer of the conference operates the client terminal 15 and selects whether to store the original conference material (conference material registered beforehand) in the document management server 11. If the organizer of the conference selects to store the original conference material in the document management server 11, the client terminal 15 proceeds to step S12 where it prompts the organizer to set up a storage destination directory in the document management server 11. On the other hand, if the organizer does not select to store the original conference material in the document management server 11, the client terminal 15 may skip step S12.

Next, in step S13, the organizer of the conference operates the client terminal 15 to select whether to store the conference material after the conference having additional information added thereto in the document management server 11. If the organizer of the conference selects to store the conference material after the conference with the additional information added thereto in the document management server 11, the client terminal 15 proceeds to step S14 where it prompts the organizer to set up a storage destination directory in the document management server 11. On the other hand, if the organizer of the conference does not select to store the conference material with the additional information in the document management server 11, the client terminal 15 may skip step S14.

In step S15, the organizer of the conference operates the client terminal 15 to select whether to store conference material after the conference having additional information added in private mode in the document management server 11. If the organizer selects to store the conference material with additional information added in private mode in the document management server 11, the client terminal 15 proceeds to step S16 where it prompts the organizer to set up a storage destination directory in the document management server 11.

On the other hand, if the organizer does not select to store the conference material with additional information added in private mode in the document management server 11, the client terminal 15 may skip step S16. Note that the setup process of step S16 may include designating whether to allow storage of the conference material with additional information added in private mode in the document management server 11 and prohibiting downloading of the conference material from the document management server 11 in a case where the conference material is highly confidential, for example. That is, the organizer may use setting options of the document management server 11 to impose tight restrictions on access authority with respect to a conference material that is highly confidential so that confidentiality of the conference material may be protected.

For example, the document management server 11 may store the conference material with additional information added in private mode in the storage destination directory set up in the document management server 11 in association with user identification information such as a user name and a user ID of the participant that has added the additional information. By tying an access authority function of the document management server 11 with the user identification information, the document management server 11 may be set up to allow only the particular participant that has added the additional information to view the conference material with the additional information added in private mode, for example.

As can be appreciated from above, by implementing the process steps of FIG. 10, the organizer of the conference may set up how the conference material is to be stored in the document management server 11 after the conference is over.

<<Registration Process from Conference Server to Document Management Server>>

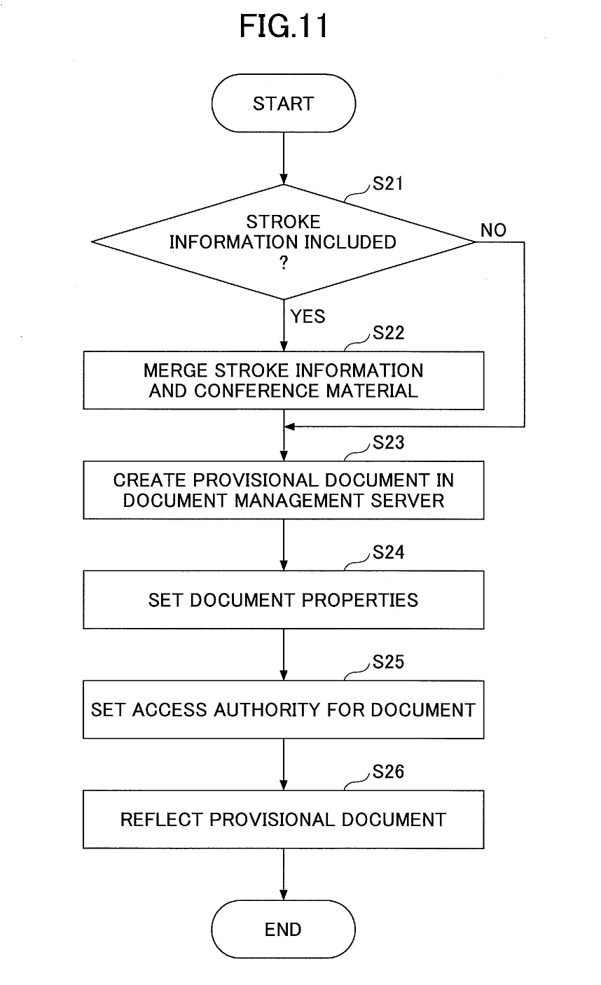

FIG. 11 is a flowchart illustrating exemplary process steps for registering conference material from the conference server 10 to the document management server 11. For example, the document management server 11 may be set up to store conference material by the process steps of FIG. 10, and after a conference is over, the conference server 10 may register conference material as a document in the document management server 11 according to the process steps of FIG. 11.

In step S21, the conference server 10 determines whether stroke information is included in the additional information added to the conference material to be stored in the document management server 11. If stroke information is included in the additional information, the conference server 10 proceeds to step S22 where it merges the stroke information with the conference material to create one single document (document to be registered). On the other hand, if stroke information is not included in the additional information, the conference server 10 may skip the process of step S22 and process the conference material to create the document to be registered.

In step S23, the conference server 10 generates a provisional version of the document to be registered in the storage destination directory set up in the document management server 11 via an API (Application Programming Interface) of the document management server 11. Note that the provisional document may not be viewed by a user of the document management server 11 until end processing is performed. At the stage of step S23, electronic data of the conference material is registered in the storage destination directory set up in the document management server 11.

In step S24, the conference server 10 sets up document properties of the document to be registered at the document management server 11. The document properties of the document may include information items stored as conference information in the conference server 10 such as the scheduled date/time and tag information, for example. In step S25, the conference server 10 sets up access authority for the document to be registered. The access authority setting may include designating persons that are authorized to access the document and persons that are not authorized to access the document, for example.

In a case of not allowing any one other than an administrator to download or retrieve the document, for example, full control may be assigned to the administrator and view restrictions may be imposed on other users. Also, access authority may be set up so that only a specific user may view the document. For example, access authority for a document corresponding to conference information with additional information added thereto may be set up so that only the user that has added the additional information to the conference material may access the document. Further, access authority for a document corresponding to conference information with additional information added in share mode may be set up so that only participants of the conference may have access to the document, for example.

After the processes of setting up the document properties and setting up the access authority for the document are completed, and settings for the document to be registered are completed, the conference server 10 proceeds to step S26 to perform end processing on the provisional document so that the provisional document may be reflected. By reflecting the provisional document, the user of the document management server 11 may be able to visually perceive the provisional document.

<<Relationship Between Conference Information and Document Information>>

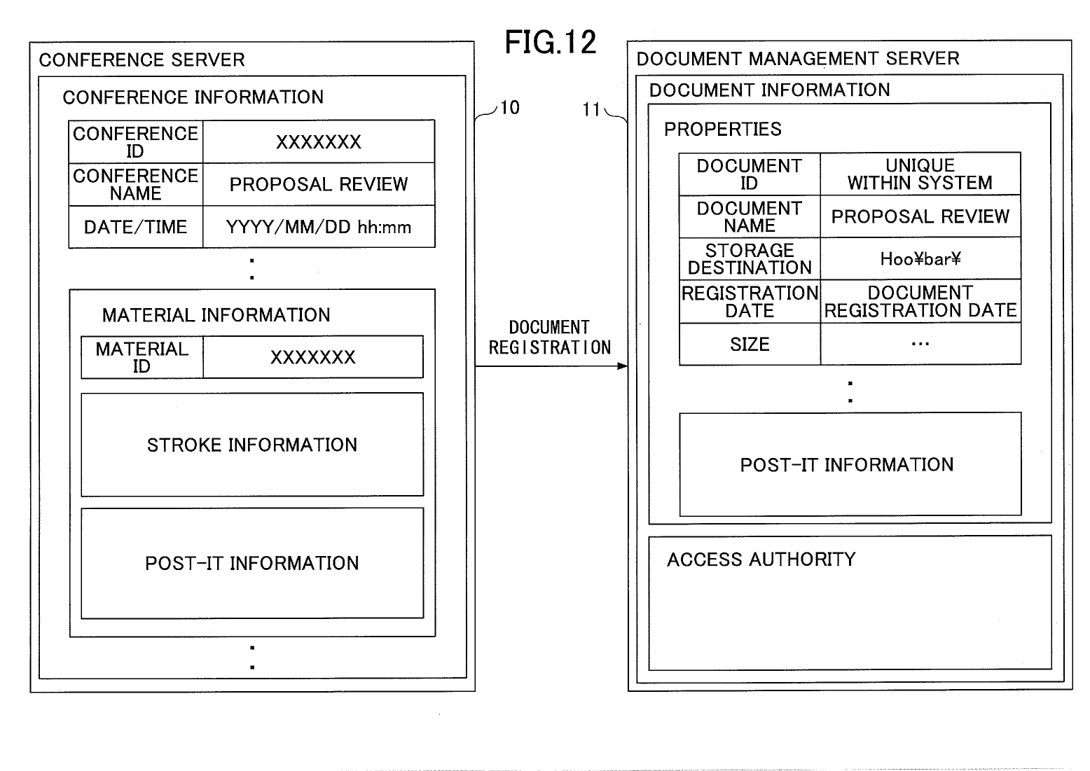

FIG. 12 illustrates an exemplary relationship between conference information and document information. The conference server 10 includes conference information as illustrated in FIG. 12, for example. The conference information includes information on the conference and information on the conference material. For example, in the case of registering the conference material included in the conference information stored in the conference server 10 as illustrated in FIG. 12, document information as illustrated in FIG. 12 may be registered in the document management server 11.

As described above with reference to FIG. 11, stroke information included in the conference information is merged with the conference material.

Information items of the conference information other than the stroke information are registered in the document management server 11 as document properties of document information. For example, a document name included in the document properties is derived from the conference name included in the conference information. A storage destination included in the document properties corresponds to the storage destination directory set up in the document management server 11. The tag information included in the document properties is derived from tag information included in the conference information. The tag information may include information items such as tag color, page, and tag comment as described above.

Note that values for other document properties may be assigned by the document management server 11 and do not necessarily have to be registered from the conference server 10. Note however, that the document properties may be arbitrarily increased, and information such as the organizer or location of the conference may be automatically registered from the conference server 10 to the document management server 11, for example.

<<Setting Up Access Authority>>

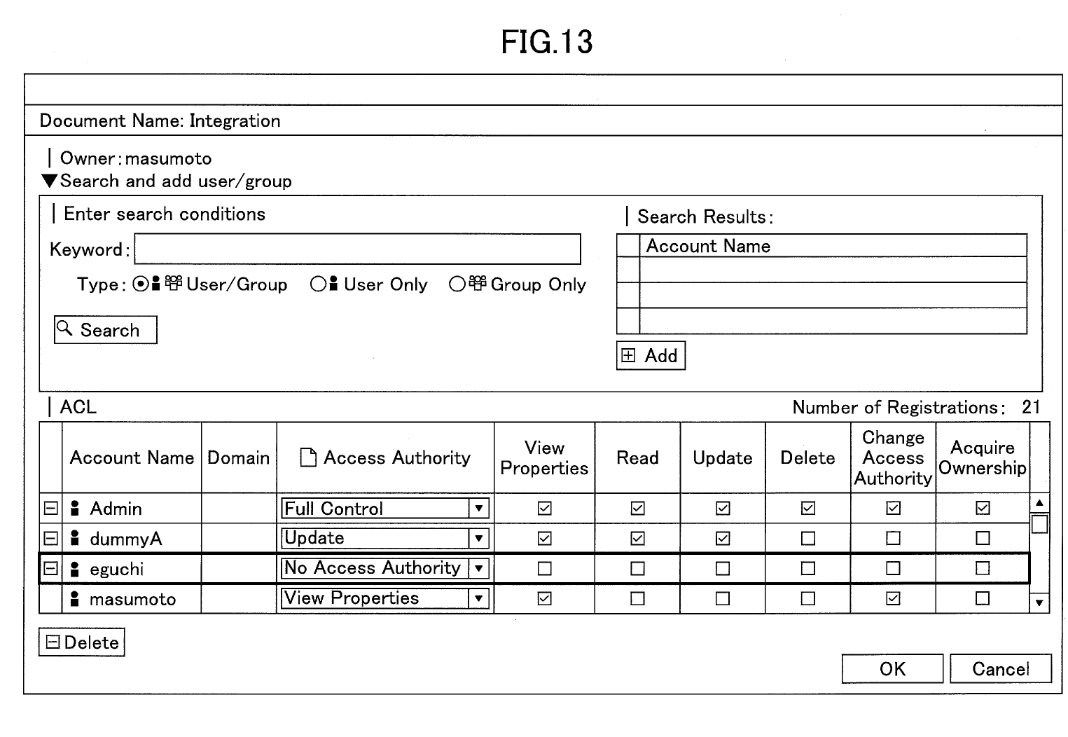

FIG. 13 illustrates an exemplary screen for setting up access authority in the document management server 11. In the screen of FIG. 13, access authority may be set up with respect to each user. For example, the process of setting up access authority for the document to be registered in step S25 of FIG. 11 may be performed using the screen as illustrated in FIG. 13 via an API of the document management server 11.

<<Viewing Document Stored in Document Management Server>>

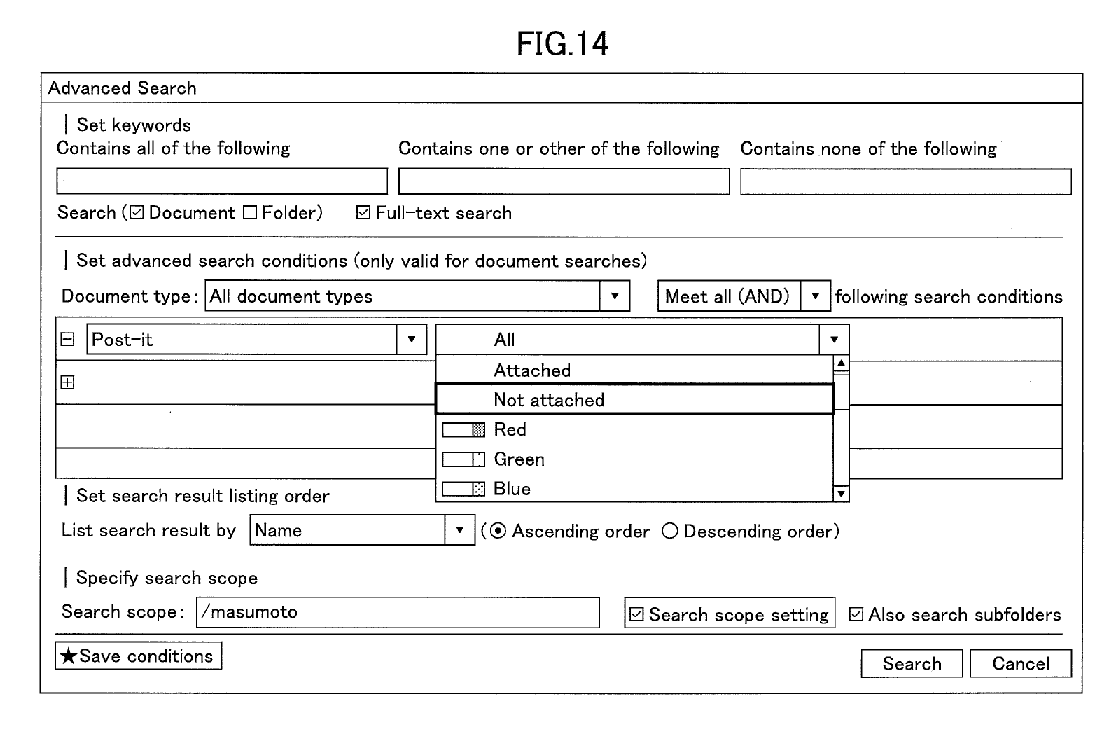

The document management server 11 may prompt the client terminal 15 to display of a search screen as illustrated in FIG. 14 when a search button is selected from a tool bar or a search option is selected from a menu, for example. FIG. 14 illustrates an exemplary search screen for conducting an advanced search.

When registering a document from the conference server 10 to the document management server 11, information relating to the conference and tag information that are stored in the conference server 10 are registered in the document management server 11 as document properties as illustrated in FIG. 12.

By registering the tag information as document properties in the document management server 11, tag information added to the conference material may be uniformly managed with the document, and the search function of the document management server 11 may be applied to the tag information.

For example, the document management server 11 may search a document based on tag information added to the conference material during the conference. In the case of searching for a document based on a document property, a user may select from the search screen the document property to be used in the document search.

In the example illustrated in FIG. 14, tag information is selected as the document property to be used in the document search. Further, in FIG. 14, the user is prompted to set up a search condition for searching a document using the tag information. For example, documents having tags attached thereto, documents without tags, or documents having tags in a certain color attached thereto may be designated as a search condition relating to tag information.

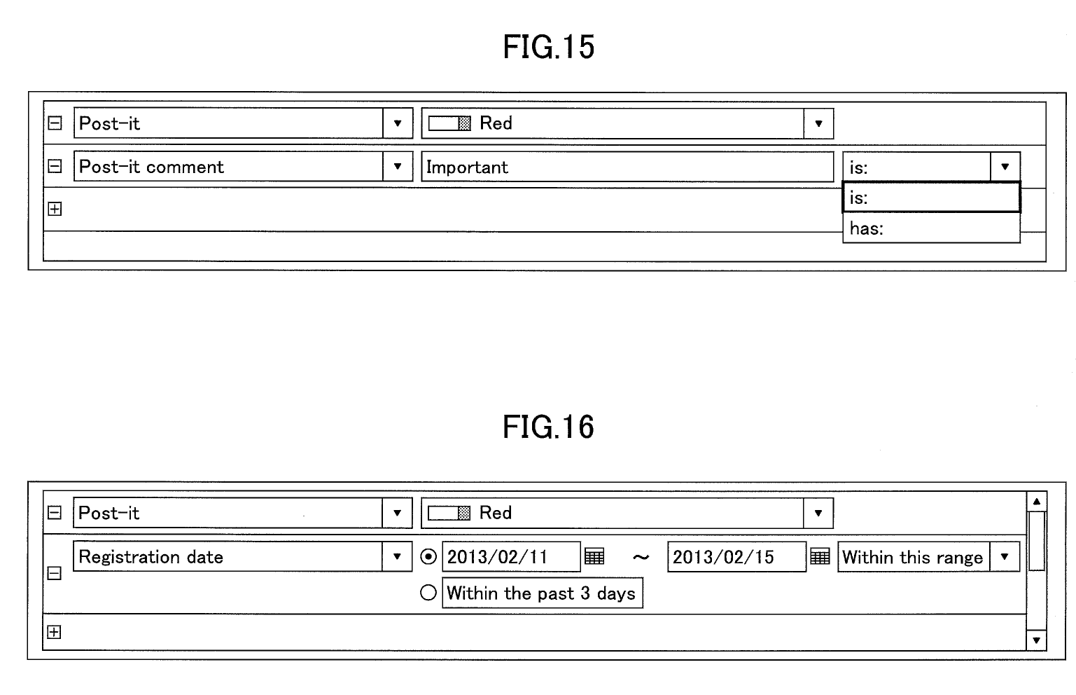

Also, the document management server 11 may conduct a document search based on a combination of multiple document properties and search conditions. FIG. 15 illustrates an exemplary search screen for searching a document based on a combination of a search condition relating to tag information as illustrated in FIG. 14 and a search condition relating to the content of a tag comment. FIG. 16 illustrates an exemplary search screen for searching a document based on a combination of a search condition relating to tag information as illustrated in FIG. 14 and a search condition relating to a document registration date.

Note that “meet all (AND)” or “meet one or other (OR)” may be selected with respect to a search condition relating to a document property.

According to an aspect of the present embodiment, by having the conference server 10 register information relating to a conference and tag information added to the conference material during the conference in the document management server 11 as document properties, the conference material and tag information added to the conference material may be effectively utilized.

<<Document List Screen by Document Management Server>>

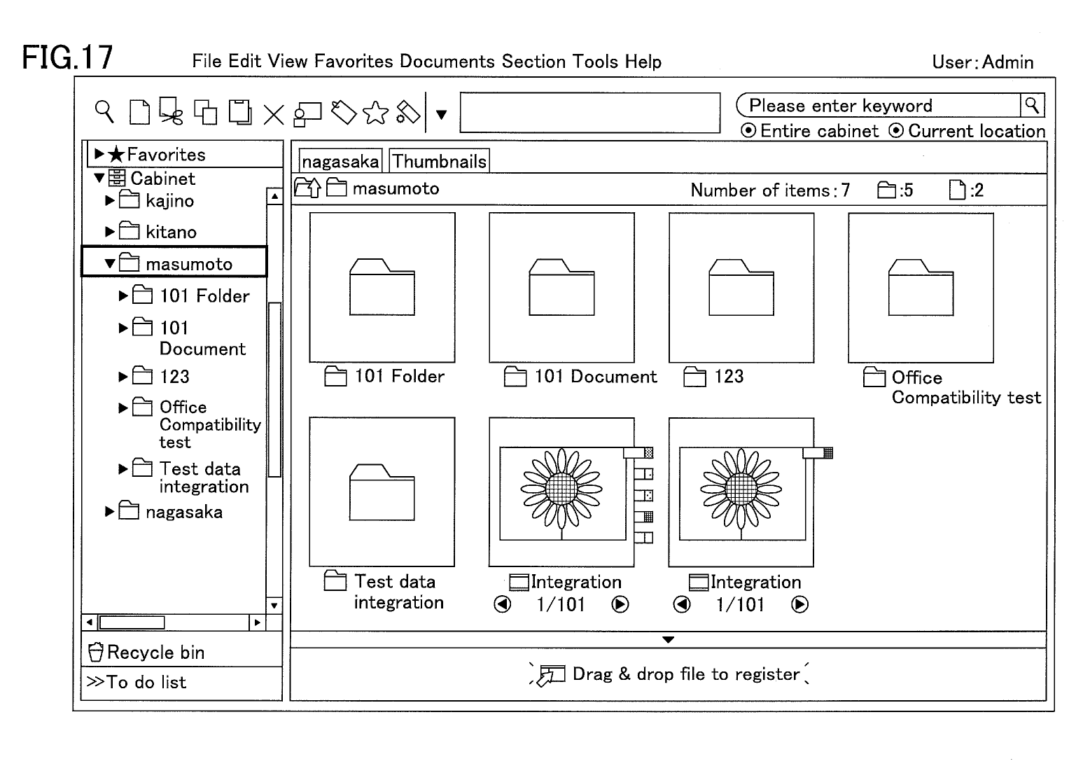

The document management server 11 may prompt the client terminal 15 to display a document list screen as illustrated in FIG. 17, for example. FIG. 17 illustrates an exemplary document list screen. The document list screen of FIG. 17 may display documents registered in the document management server 11 in a manner such that if the document corresponds to conference material merged with stroke information, the conference material is displayed with the stroke added thereto.

Because tag information is registered as document properties in the document management server 11, if the document to be displayed includes tag information, the document list screen of FIG. 17 may visually represent the tag information as a tag attached to the document. Note that in a case where multiple tags are displayed and a tag that is attached to a page other than a currently displayed page is selected by the user, the document list screen of FIG. 17 may switch to displaying the page having the selected tag attached thereto, for example.

<<Viewer Screen by Document Management Server>>

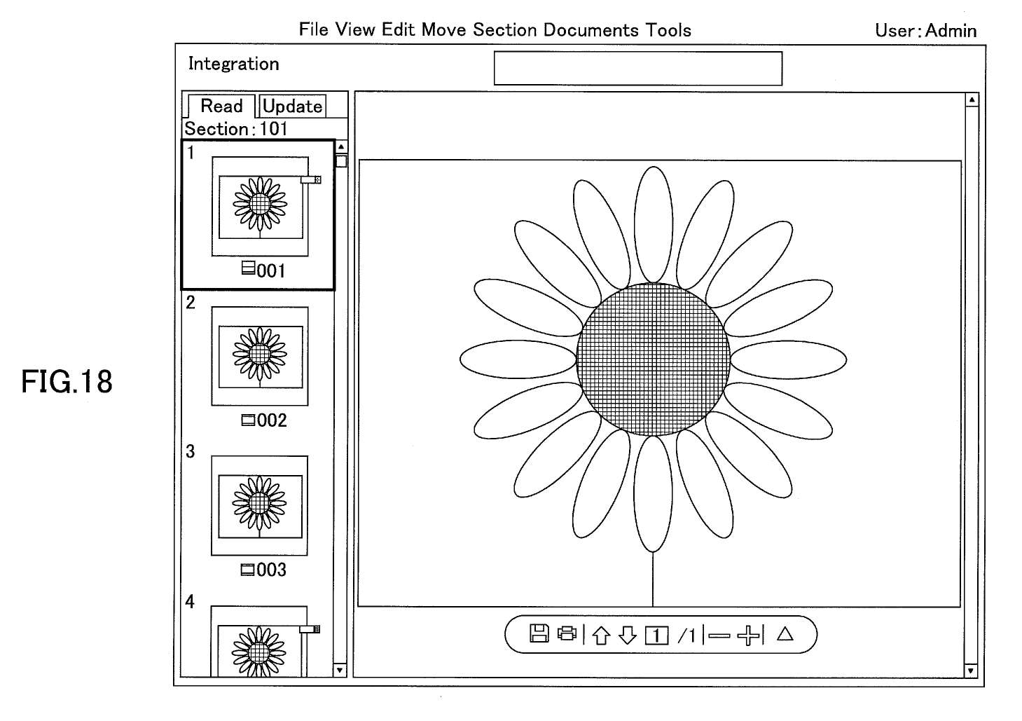

The document management server 11 may prompt the client terminal 15 to display a viewer screen as illustrated in FIG. 18, for example. FIG. 18 illustrates an exemplary viewer screen. The viewer screen of FIG. 18 may be displayed when a document is selected from the document list screen of FIG. 17, for example. Note that the viewer screen of FIG. 18 has a thumbnail list displayed at its left side. The thumbnail list includes thumbnail images of pages of the selected document. If a page of a document has a tag attached thereto, the tag is visually represented in the thumbnail image of the page.

<<Other Processes>>

Although tag information is registered as document properties in the information processing system 1 according to the present embodiment, stroke information may also be registered as document properties. For example, if the stroke information corresponds to a character string, OCR (Optical Character Recognition) may be applied and a full-text search may be conducted with respect to the stroke information.

<Summary>

As described above, in the information processing system 1 according to the present embodiment, when registering conference material from the conference server 10 as a document in the document management server 11, additional information added to the conference material such as tag information may be registered as document properties. Accordingly, even after the conference is over, a document search may be conducted based on the tag attached to the conference material, or the tag may be used to turn a page being displayed on a screen, for example. In this way, utility of the additional information added to the conference material may be enhanced, for example.

Although the present invention has been described above with reference to certain preferred embodiments, the present invention is not limited to these embodiments, and numerous variations and modifications may be made without departing from the scope of the present invention.

Note that the conference server 10 described above corresponds to an exemplary embodiment of a conference apparatus. The document management server 11 corresponds to an exemplary embodiment of a document management apparatus. The client terminal 15 corresponds to an exemplary embodiment of a terminal apparatus. The conference material described above corresponds to an example of content, and the document property corresponds to an example of property information. The information management unit 23 of the conference server 10 corresponds to an exemplary embodiment of a conference information management unit. The information processing unit 21 and the communication unit 22 of the conference server 10 correspond to an exemplary embodiment of a document registration unit. The information management unit 34 of the document management server 11 corresponds to en exemplary embodiment of a document information management unit.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Application No. 2013-045785 filed on Mar. 7, 2013, the entire contents of which are hereby incorporated by reference.

What is claimed is:

1. An information processing system having a conference apparatus, a document management apparatus, and a plurality of terminal apparatuses interconnected via a network, the information processing system comprising:
a conference information management unit that prompts the conference apparatus to manage conference information including information on an electronic conference, content shared by the plurality of terminal apparatuses at the electronic conference, and additional information added to the content at the plurality of terminal apparatuses;
a document registration unit that registers document information corresponding to the conference information managed by the conference apparatus in the document management apparatus and prompts a transition from management by the conference apparatus to management by the document management apparatus, the document information being configured to be managed by the document management apparatus;
a document information management unit that manages the document information; and
a display control unit that prompts the terminal apparatuses to visually display the additional information added to the content using the additional information included in the document information.

2. The information processing system as claimed in claim 1, wherein the document registration unit sets up at least a part of the additional information included in the conference information as property information included in the document information.

3. The information processing system as claimed in claim 2, wherein the document registration unit consolidates a part of the additional information included in the conference information with the content and sets up the consolidated information as a document represented by the document information.

4. The information processing system as claimed in claim 1, wherein the document registration unit sets up access authority for enabling a participant of the electronic conference to access the document information via the terminal apparatuses based on the information on the electronic conference included in the conference information.

5. The information processing system as claimed in claim 1, wherein the document registration unit sets up access authority for enabling a participant of the electronic conference that has added the additional information to the content at the terminal apparatuses to access the document information via the terminal apparatuses.

6. The information processing system as claimed in claim 1, further comprising:
a search unit that searches the content having the additional information added thereto using the additional information included in the document information.

7. The information processing system as claimed in claim 3, wherein the document registration unit consolidates handwritten information included in the additional information of the conference information with the content, sets up the consolidated information as document data represented by the document information, and sets up tag information included in the additional information as property information included in the document information.

8. The information processing system as claimed in claim 7, wherein the display control unit displays the handwritten information added to the content based on the document data represented by the document information and displays the tag information added to the content based on the property information included in the document information.

9. An information processing system having a program installed in a conference apparatus, a program installed in a document management apparatus, and a plurality of terminal apparatuses interconnected via a network, the information processing system comprising:
a conference information management unit that prompts the conference apparatus to manage conference information including information on an electronic conference, content shared by the plurality of terminal apparatuses at the electronic conference, and additional information added to the content at the plurality of terminal apparatuses;
a document registration unit that registers document information corresponding to the conference information managed by the conference apparatus in the document management apparatus and prompts a transition from management by the conference apparatus to management by the document management apparatus, the document information being configured to be managed by the document management apparatus;
a document information management unit that manages the document information; and
a display control unit that prompts the terminal apparatuses to visually display the additional information added to the content using the additional information included in the document information.

10. An information registration method that is implemented by an information processing system having a conference apparatus, a document management apparatus, and a plurality of terminal apparatuses interconnected via a network, the information registration method comprising:
a conference information managing step of having the conference apparatus manage conference information including information on an electronic conference, content shared by the plurality of terminal apparatuses at the electronic conference, and additional information added to the content at the plurality of terminal apparatuses;
a registration step of registering document information corresponding to the conference information managed by the conference apparatus in the document management apparatus and prompting a transition from management by the conference apparatus to management by the document management apparatus, the document information being configured to be managed by the document management apparatus;
a document information managing step of managing the document information; and
a display controlling step of prompting the terminal apparatuses to visually display the additional information added to the content using the additional information included in the document information.
